(19) United States
(12) Patent Application Publication
(10) Pub. No.: US 2025/0308001 A1
(43) Pub. Date: Oct. 2, 2025

(54) IMAGE PROCESSING METHOD, SYSTEM AND ELECTRONIC DEVICE

(71) Applicant: Beijing Lenovo Software Ltd., Beijing (CN)

(72) Inventors: Sheng SHI, Beijing (CN); Hong PAN, Beijing (CN)

(21) Appl. No.: 19/091,201

(22) Filed: Mar. 26, 2025

(30) Foreign Application Priority Data
Mar. 28, 2024 (CN) 202410367951.6

(51) Int. Cl. G06T 5/70; G06T 5/50

(52) U.S. Cl. CPC G06T 5/70; G06T 5/50; G06T 2207/20221

(57) ABSTRACT

The disclosure describes an image processing method, an image processing system and an electronic device. The method includes obtaining an initial image; based on text information and a mask image, performing denoise processing on latent variables corresponding to the initial image to obtain latent variables corresponding to a first region in the initial image, where the text information is used to indicate modification of image content of the first region, and the mask image corresponds to the first region; and using the mask image to fuse the latent variables corresponding to the first region and latent variables corresponding to a second region to obtain a target image, the target image including the first region in the initial image whose image content is modified and the second region in the initial image, where the second region refers to a remaining region in the initial image except the first region.

### CROSS-REFERENCE TO RELATED APPLICATION

This application claims priority to Chinese Patent Application No. 202410367951.6, filed on Mar. 28, 2024, the content of which is incorporated herein by reference in its entirety.

### TECHNICAL FIELD

The present disclosure relates to the field of image processing technology, and in particular to an image processing method, system and electronic device.

### BACKGROUND

With the development of technology, deep learning-based image generation models are currently used to generate images under the guidance of text that reflects user intentions. Most image generation models focus on generating images from scratch based on input text, or adjusting an original image based on the input text. When an image generation model adjusts the original image based on the input text, even if the input text merely targets part of the image content in the original image, the resulting image will be quite different from the original image, making it impossible to achieve regional adjustment of the original image.

### SUMMARY

In view of the foregoing, embodiments of the disclosure provide an image processing method, an image processing system and an electronic device. The technical solutions of the embodiments of the disclosure are implemented as follows.

In one aspect, embodiments of the disclosure provide an image processing method, and the method includes: obtaining an initial image; based on text information and a mask image, performing denoise processing on latent variables corresponding to the initial image to obtain latent variables corresponding to a first region in the initial image, where the text information is used to indicate modification of image content of the first region, and the mask image corresponds to the first region; and using the mask image to fuse the latent variables corresponding to the first region and latent variables corresponding to a second region to obtain a target image, the target image including the first region in the initial image whose image content is modified and the second region in the initial image, where the second region refers to a remaining region in the initial image except the first region.

In another aspect, embodiments of the disclosure provide an image processing system, including a memory and one or more processors, where the memory stores a computer program executable by the one or more processors, and when executing the computer program, the one or more processor are configured to perform: obtaining an initial image; based on text information and a mask image, performing denoise processing on latent variables corresponding to the initial image to obtain latent variables corresponding to a first region in the initial image, where the text information is used to indicate modification of image content of the first region, and the mask image corresponds to the first region; and using the mask image to fuse the latent variables corresponding to the first region and latent variables corresponding to a second region to obtain a target image, the target image including the first region in the initial image whose image content is modified and the second region in the initial image, where the second region refers to a remaining region in the initial image except the first region.

In another aspect, embodiments of the disclosure provide a non-transitory computer-readable storage medium, storing a computer program that, when being executed, causes at least one processor to implement an image processing method including: obtaining an initial image; based on text information and a mask image, performing denoise processing on latent variables corresponding to the initial image to obtain latent variables corresponding to a first region in the initial image, where the text information is used to indicate modification of image content of the first region, and the mask image corresponds to the first region; and using the mask image to fuse the latent variables corresponding to the first region and latent variables corresponding to a second region to obtain a target image, the target image including the first region in the initial image whose image content is modified and the second region in the initial image, where the second region refers to a remaining region in the initial image except the first region.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions of the embodiments of the disclosure, the drawings essential for understanding the description of the embodiments will be briefly introduced below. Apparently, the drawings described below are merely some embodiments of the disclosure. For a person skilled in the art, other drawings may be obtained based on these drawings without making creative efforts.

FIG. 1 is a flowchart of an image processing method, according to Embodiment 1of the disclosure;

FIG. 2 is a schematic diagram of implementing regional image adjustment, according to some embodiments of the disclosure;

FIG. 3 is a schematic diagram of implementing regional image adjustment through an image processing system, according to some embodiments of the disclosure;

FIG. 4 is a schematic diagram of a process for implementing regional image adjustment, according to some embodiments of the disclosure;

FIG. 5 is a schematic diagram of another process for implementing regional image adjustment, according to some embodiments of the disclosure;

FIG. 6 is a flowchart of part of an image processing method, according to Embodiment 1 of the disclosure;

FIG. 7 is a schematic diagram of another process for implementing regional image adjustment, according to some embodiments of the disclosure;

FIG. 8 is a schematic diagram of another process for implementing regional image adjustment, according to some embodiments of the disclosure;

FIG. 9 is a schematic structural diagram of an image processing system, according to Embodiment 2 of the disclosure;

FIG. 10 is a schematic structural diagram of an electronic device, according to Embodiment 3 of the disclosure;

FIG. 11 is a schematic diagram of implementing regional image adjustment through an text-to-image diffusion model, according to some embodiments of the disclosure;

FIG. 12 is a schematic diagram of image fusion performed by a controllable fusion module at stage 1, according to some embodiments of the disclosure; and

FIG. 13 is a schematic diagram of image fusion performed by a controllable fusion module at stage 2, according to some embodiments of the disclosure.

### DETAILED DESCRIPTION

In order to enable those skilled in the art to better understand the solutions of the disclosure, the technical solutions in the embodiments of the disclosure will be clearly and thoroughly described below in conjunction with the drawings in the embodiments of the disclosure. Apparently, the described embodiments are merely part of the embodiments of the disclosure, not all of the embodiments. Based on the embodiments in the disclosure, other embodiments obtained by a person skilled in the art without making creative efforts are within the scope of protection of the present disclosure.

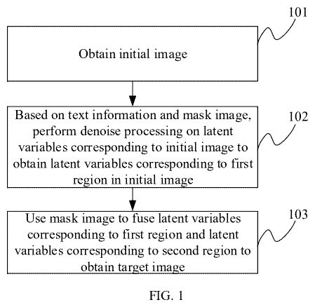

FIG. 1 is a flowchart of an image processing method according to Embodiment 1 of the disclosure. The method may be applied to an electronic device capable of data processing, such as a computer or server. The electronic device is configured with an image processing system, which may include corresponding functional modules, such as an input module, a denoising module, and a fusion module, and may also include an encoding module and a decoding module, etc., where the fusion module may be a controllable fusion module (CFM). The technical solutions in the embodiments disclosed herein is mainly used to achieve regional adjustment of an image.

Specifically, the method in the disclosed embodiments may include the following steps.

Step 101: Obtain an initial image.

Here, the initial image may be obtained through an input module in the image processing system.

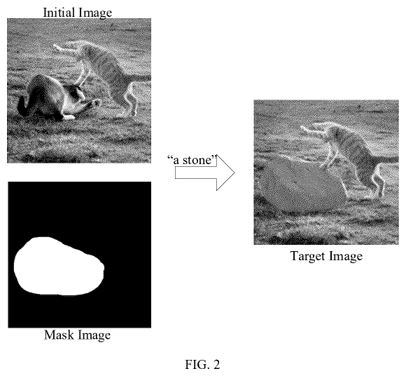

It should be noted that the initial image is an image that needs to be regionally adjusted. For example, as shown in FIG. 2, the initial image includes an orange cat and a Siamese cat, and the orange cat is located at the upper right position of the Siamese cat. In this illustrated embodiment, the region where the Siamese cat is located in the initial image needs to be adjusted.

Here, the initial image may be encoded to obtain latent variables corresponding to the initial image, which may be represented by Zᵢₙᵢₜ.

Step 102: Based on text information and a mask image, perform denoise processing on latent variables corresponding to the initial image to obtain latent variables corresponding to a first region in the initial image.

The text information is used to indicate the modification of image content of the first region, and the mask image corresponds to the first region.

For example, taking the initial image shown in FIG. 2 as an example, the text information may be “a stone” to indicate that the first region in the initial image is changed into stone, and the mask image is the region corresponding to the Siamese cat.

In some embodiments, the first region in the initial image may be determined by the mask image, so that latent variables corresponding to the first region may be denoised based on the text information, to obtain the latent variables corresponding to the first region in the initial image. The latent variables corresponding to the first region obtained in this way is the latent variables corresponding to the first region after the image content is modified.

In some embodiments, the latent variables corresponding to the initial image may be denoised based on the text information, and then the latent variables corresponding to the first region in the initial image may be determined through the mask image. The latent variables corresponding to the first region obtained in this way are the latent variables corresponding to the first region after the image content is modified.

Here, the latent variables corresponding to the initial image may be denoised by a denoising module in the image processing system.

Step 103: Use the mask image to fuse the latent variables corresponding to the first region and latent variables corresponding to a second region to obtain a target image.

The target image includes the first region in the initial image whose image content is modified and a second region in the initial image, where the second region refers to the remaining region in the initial image except the first region.

In some embodiments, in Step 103, the latent variables corresponding to the second region may be obtained first, and then the latent variables corresponding to the first region and the obtained latent variables corresponding to the second region may be fused using the mask image to obtain the target image.

In some embodiments, the hidden variables corresponding to the second region may be obtained by using a reverse mask image corresponding to the mask image to intercept the remaining region except the first region in the latent variables corresponding to the initial image, to obtain the latent variables corresponding to the second region. It should be noted that the hidden variables corresponding to the second region here refer to the hidden variables obtained after the hidden variables corresponding to the first region in the initial image are processed to be null through the reverse mask image.

It should be noted that before obtaining the latent variables corresponding to the second region, in some embodiments, noise data may not be added to the latent variables corresponding to the initial image. Afterwards, the reverse mask image corresponding to the mask image is used to intercept the remaining region except the first region in the latent variables corresponding to the initial image to obtain the latent variables corresponding to the second region. The latent variables corresponding to the second region are then fused with the latent variables corresponding to the first region using the mask image to obtain the target image.

Alternatively, before obtaining the latent variables corresponding to the second region, in some embodiments, noise data may be added to the latent variables corresponding to the initial image, and the noise amplitude of the added noise data is zero. Afterwards, the reverse mask image corresponding to the mask image is used to intercept the remaining region except the first region in the latent variables corresponding to the initial image to obtain the latent variables corresponding to the second region. The latent variables corresponding to the second region are then fused with the latent variables corresponding to the first region using the mask image to obtain the target image.

Alternatively, before obtaining the latent variables corresponding to the second region, in some embodiments, noise data may be added to the latent variables corresponding to the initial image, and the noise amplitude of the added noise data is not zero. Afterwards, the reverse mask image corresponding to the mask image is used to intercept the remaining region except the first region in the latent variables corresponding to the initial image to obtain the latent variables corresponding to the second region. The latent variables corresponding to the second region are fused with the latent variables corresponding to the first region using the mask image to obtain the target image. The latent variables corresponding to the target image are then denoised based on the text information to obtain a more accurate target image.

In some embodiments, in Step 103, the mask image may be used to fuse the latent variables corresponding to the first region and the latent variables corresponding to the initial image including the second region to obtain the target image.

It should be noted that if noise data is added to the latent variables corresponding to the initial image containing the second region, based on this, after Step 103, the latent variables corresponding to the target image may be denoised again based on the text information to obtain a more accurate target image.

In the disclosed embodiments, the latent variables corresponding to the initial image may be denoised by a fusion module in the image processing system.

It should be noted that the target image may be obtained by decoding the latent variables obtained by the denoise processing using the decoding module.

It can be seen that in an image processing method provided in Embodiment 1 of the disclosure, a mask image may be used to modify the image content of the first region in the initial image based on text information, the image content of the first region after modification may be then fused with the remaining region. In this way, when performing image processing, the first region may be adjusted without causing major changes to the remaining region, thereby achieving regional adjustment of the image.

In some embodiments, the denoise processing for the latent variables corresponding to the initial image in Step 102 may be performed multiple times, and the latent variables obtained from a previous denoise processing are used as the latent variables for the next denoising process. The latent variables corresponding to the first region obtained from the final denoise processing are fused with the latent variables corresponding to the second region in the initial image to obtain the target image.

It should be noted that, before the latent variables corresponding to the initial image are denoised for the first time, first noise data is added to the latent variables corresponding to the initial image. Based on this, after the target image is obtained in Step 103, the target image may be denoised based on the text information to obtain a more accurate target image.

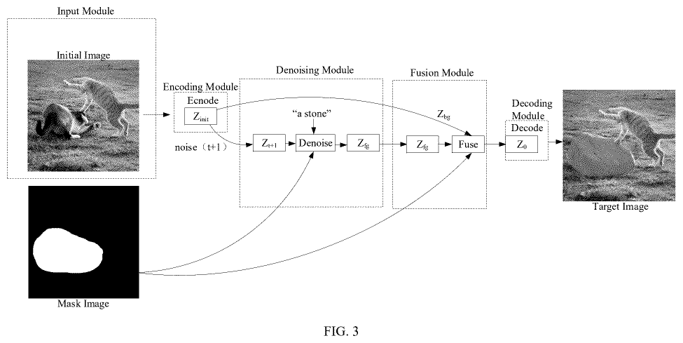

For example, as shown in FIG. 3, the corresponding image processing may be implemented respectively by the input module, the denoising module and the fusion module in the image processing system. After the initial image shown in FIG. 2 is obtained by the input module, the initial image is then encoded by an encoding module such as an encoder to obtain hidden variables corresponding to the initial image, represented by Zᵢₙᵢₜ. Then, the first noise data is added to the hidden variables corresponding to the initial image, and the first noise data may be represented by noise(t+1), and the hidden variables corresponding to the initial image are obtained, that is, Zₜ₊₁. Then, the denoising module is used to perform multiple denoising processes on the hidden variables corresponding to the initial image based on the text information and the mask image, so as to obtain the hidden variables corresponding to the region where the Siamese cat is located, which may also be referred to as the hidden variables corresponding to the foreground region, represented by Z_{fg}. Correspondingly, the remaining region in the initial image except the foreground region are referred to as the background region, and the hidden variables corresponding to the background region may be represented by Z_{bg}. Based on this, the fusion module uses the mask image to fuse the latent variables corresponding to the foreground region and the latent variables corresponding to the background region, to obtain the foreground region with the image content modified to “a stone” and the original background region, so as to obtain the latent variables corresponding to the target image, that is, Z₀. Finally, the latent variables corresponding to the target image are denoised based on text information such as “a stone”, and then decoded by a decoding module such as an decoder to obtain a more accurate target image, which contains the foreground region where the stone is located and the background region where the orange cat is located.

In addition, before the latent variables corresponding to the initial image are denoised for the first time, the mask image may be downsampled according to the latent variables corresponding to the initial image, so that the mask image and the latent variables corresponding to the initial image have a consistent image size. Moreover, the mask image used for each denoise processing is smoothed according to different processing parameters. For example, the latent variables corresponding to the initial image are of size 1680*1680. Based on this, the mask image (i.e., mask) is downsampled so that the mask image is also of size 1680*1680. Moreover, before each denoise processing is performed, the mask image is smoothed to different degrees according to different smoothing parameters, to obtain the mask image(s) participating in the denoising process.

In some embodiments, the multiple denoising processes in Step 102, especially the denoise processing of the latent variables corresponding to the initial image in the first N times, may be implemented in the following manner.

First, using the mask image, the latent variables corresponding to the initial image are processed to obtain the latent variables corresponding to the first region in the initial image.

Then, based on the text information, the latent variables corresponding to the first region in the initial image are denoised to obtain the denoised latent variables corresponding to the first region.

Here, N is a positive integer greater than or equal to 1. The maximum value of N may be the total number of executions of the denoising process.

It can be seen that in the disclosed embodiments, in the first N denoising processes, image modification is performed just on the first region based on the text information, and the second region in the initial image does not participate in the image modification of the first region, so that the image modification of the first region is more in line with the text information. Therefore, after the second region is finally fused, the obtained target image may achieve more accurate regional image adjustment.

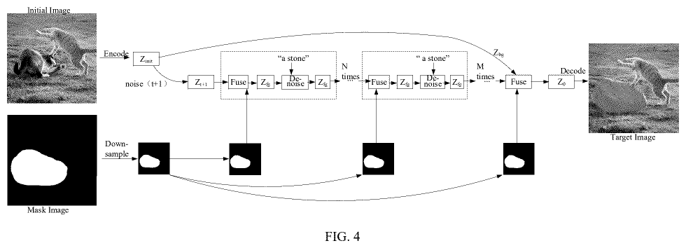

For example, as shown in FIG. 4, the corresponding image processing may be implemented respectively by the input module, the denoising module and the fusion module in the image processing system. After the initial image shown in FIG. 2 is obtained by the input module, the initial image is firstly encoded by the encoding module to obtain the latent variables corresponding to the initial image, represented by Zinit, The first noise data noise(t+1) is then added to the latent variables corresponding to the initial image to obtain the latent variables corresponding to the initial image, i.e., Zₜ₊₁. Next, the denoising module and the fusion module are firstly used to perform N denoising processes, and each denoise processing is as follows.

First, use the fusion module through the mask image to intercept the hidden variables corresponding to the foreground region in the initial image, that is, Z_{fg}. It should be noted that the hidden variables corresponding to the foreground region here are also the hidden variables of the full image, whose size is consistent with the initial image, but the hidden variables corresponding to the background region are processed to be null through the mask image.

Then, the denoising module is used to denoise the latent variables corresponding to the foreground region in the initial image based on the text information, so as to obtain the denoised latent variables corresponding to the foreground region in the initial image.

Afterwards, the fusion module is used again to process the denoised latent variables corresponding to the initial image including the foreground region through the mask image, to obtain new latent variables corresponding to the foreground region.

Then, the denoising module is used to denoise new latent variables corresponding to the foreground region again based on the text information, to obtain new denoised latent variables corresponding to the foreground region.

The fusion module is then used again to process, through the mask image, the new denoised latent variables corresponding to the initial image containing the foreground region again, and so on, until N denoising processes are completed. Next, subsequent M denoising processes are performed, where M may be 0 or a positive integer greater than or equal to 1. Eventually, the denoised latent variables corresponding to the foreground region are obtained, so that the denoised latent variables corresponding to the foreground region are fused with the latent variables corresponding to the background region according to the mask image through the fusion module, so that the foreground region containing the image content modified to “a stone” and the original background region may be obtained, so as to obtain the latent variables corresponding to the target image, that is, Zo. Finally, the latent variables corresponding to the target image are denoised based on text information such as “a stone”, and then decoded by the decoding module to obtain a more accurate target image, which contains the foreground region where the stone is located and the background region where the orange cat is located.

In some embodiments, the multiple denoising processes in Step 102, especially the denoise processing of the latent variables corresponding to the initial image in the last M times, may be implemented in the following way.

Firstly, based on the text information, the latent variables corresponding to the initial image are denoised to obtain denoised latent variables corresponding to the initial image.

Then, using the mask image, the denoised latent variables corresponding to the initial image are processed to obtain denoised latent variables corresponding to the first region.

Here, M is a positive integer greater than or equal to 1. The maximum value of M may be the total number of executions of the denoising process.

It can be seen that in the embodiment disclosed herein, in the last M denoising processes, the image of the first region is modified not only based on the text information but also in combination with the second region in the initial image, so that the image modification of the first region not only fits the text information, but the modified first region is also more natural with the second region. Therefore, after the second region is finally fused, the obtained target image may achieve more accurate regional image adjustment.

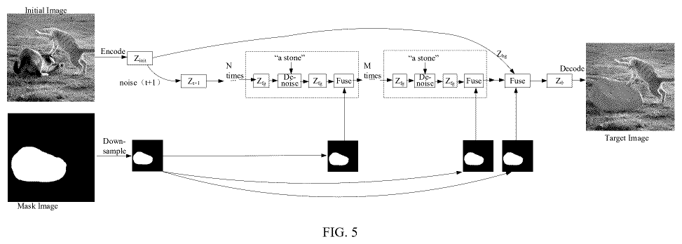

For example, as shown in FIG. 5, the corresponding image processing may be implemented respectively by the input module, the denoising module and the fusion module in the image processing system. After the initial image shown in FIG. 2 is obtained by using the input module, the initial image is firstly encoded by using the encoding module to obtain the latent variables corresponding to the initial image, represented by Zᵢₙᵢₜ. After that, the first noise data noise(t+1) is added to the latent variables corresponding to the initial image to obtain the latent variables corresponding to the initial image, i.e., Zₜ₊₁. After performing N denoising processes by the denoising module and the fusion module, the denoising module and the fusion module are then used to perform M denoising processes. Each denoise processing is as follows.

First, the denoising module is used to denoise the latent variables corresponding to the initial image based on the text information to obtain the denoised latent variables corresponding to the initial image. Here, the latent variables corresponding to the initial image are actually the latent variables corresponding to the foreground region obtained by the previous N denoising processes, that is, Z_{fg}.

Then, the fusion module is used to process the denoised initial image using the mask image to obtain the denoised hidden variables corresponding to the foreground region. It should be noted that the denoised hidden variables corresponding to the foreground region here refer to the hidden variables obtained after the hidden variables corresponding to the background region in the denoised initial image are processed to be null through the mask image.

Then, the denoising module is reused to denoise the initial image including the denoised foreground region based on the text information to obtain latent variables corresponding to the new denoised initial image.

Then, the fusion module is used to process the latent variables corresponding to the new denoised initial image using the mask image to obtain new latent variables corresponding to the foreground region.

The denoising module is then used again to process the latent variables corresponding to the denoised initial image containing the foreground region based on the text information, and so on, until the M denoising processes are completed. Eventually, the denoised latent variables corresponding to the foreground region are obtained, so that the denoised latent variables corresponding to the foreground region and the latent variables corresponding to the background region may be fused according to the mask image by using the fusion module, so that the foreground region containing the image content modified to “a stone” and the original background region may be obtained, so as to obtain the latent variables corresponding to the target image, that is, Z₀. In the end, the latent variables corresponding to the target image are denoised based on the text information such as “a stone”, and then decoded by the decoding module to obtain a more accurate target image, which contains the foreground region where the stone is located and the background region where the orange cat is located.

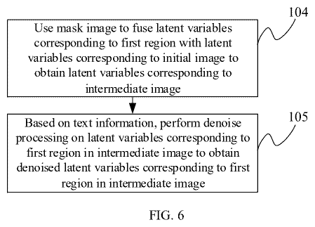

Based on the above implementation scheme, after Step 102 and before Step 103, the embodiments disclosed herein may further include executing the following steps at least once, as shown in FIG. 6.

Step 104: Using the mask image to fuse the latent variables corresponding to the first region with the latent variables corresponding to the initial image to obtain latent variables corresponding to an intermediate image.

Step 105: Based on the text information, perform denoise processing on the latent variables corresponding to the first region in the intermediate image to obtain denoised latent variables corresponding to the first region in the intermediate image.

It should be noted that after Step 105, based on the denoised hidden variables corresponding to the first region in the intermediate image, the process returns to Step 104 until the number of executions reaches a specific threshold, such as 30 times, and the loop ends. Then Step 103 is executed, that is, the hidden variables corresponding to the first region obtained in the final Step 105 are fused with the hidden variables corresponding to the second region using the mask image to obtain the target image. Furthermore, the target image is denoised based on the text information to obtain a more accurate target image.

In some embodiments, before each execution of Step 104, second noise data is first added to the latent variables corresponding to the initial image, and the second noise data added to the latent variables corresponding to the initial image used each time Step 104 is executed is different. For example, the second noise data added to the latent variables corresponding to the initial image when Step 104 is executed for the first time is represented by noise(t), and the second noise data added to the latent variables corresponding to the initial image when Step 104 is executed for the last time is represented by noise (2), and the latent variables corresponding to the second region used in Step 103 are obtained from the latent variables corresponding to the initial image to which the second noise data noise (1) is added.

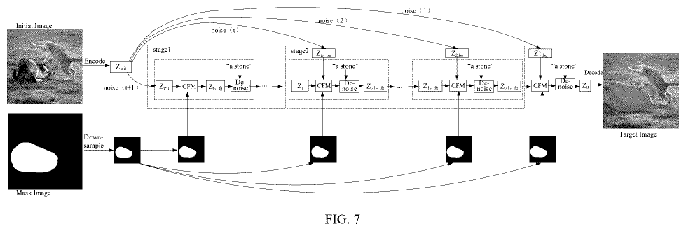

For example, as shown in FIG. 7, the corresponding image processing may be implemented respectively by the input module, the denoising module and the fusion module in the image processing system. After the initial image shown in FIG. 2 is obtained by the input module, the initial image is firstly encoded by the encoding module to obtain the latent variables corresponding to the initial image, and then the first noise data noise(t+1) is added to the latent variables corresponding to the initial image to obtain the latent variables corresponding to the initial image, i.e., Zₜ₊₁. Based on this, the following processing is performed multiple times by the denoising module and the fusion module, i.e., the processing of the stage 1 as follows.

First, the fusion module uses the mask image to intercept the hidden variables corresponding to the foreground region in the initial image, that is, Z_{t, fg}. It should be noted that the hidden variables corresponding to the foreground region here refer to the hidden variables obtained after the hidden variables corresponding to the background region in the initial image are processed to be null through the mask image.

Then, the denoising module is used to denoise the latent variables corresponding to the foreground region in the initial image based on the text information, so as to obtain the denoised latent variables corresponding to the foreground region in the initial image.

Based on this, the denoised hidden variables corresponding to the foreground region output by the denoising module is used as the hidden variable Zₜ₊₁ corresponding to the initial image to re-execute the above process until the number of executions reaches the corresponding number.

After that, the denoised latent variables corresponding to the foreground region finally output by the denoising module is taken as Z_{t,} and the following processing is performed t times through the denoising module and the fusion module, that is, the processing of the stage 2 as follows.

First, the latent variables corresponding to the foreground region are fused with the latent variables corresponding to the initial image by using the mask image through the fusion module to obtain the latent variables corresponding to the intermediate image. The latent variables corresponding to the intermediate image include the latent variables corresponding to the foreground region participating in the fusion and the latent variables corresponding to the background region in the initial image. It should be noted that the latent variables corresponding to the initial image here are added with the second noise data. The latent variables corresponding to the initial image used each time may be represented by Z_{t, bg}, Z_{t-1, bg,} . . . , Z_{2, bg}. Since each time the second noise data (such as noise(t) to noise(2)) added to the latent variables corresponding to the initial image is different, Z_{t, bg,} Z_{t-1, bg,} . . . , Z_{2, bg} are all different.

Then, the denoising module is used to denoise the latent variables corresponding to the foreground region in the intermediate image based on the text information. In this process, since the latent variables corresponding to the background region in the initial image are fused into the intermediate image, the denoised latent variables corresponding to the foreground region in the intermediate image are obtained by modifying the image based on the text information in combination with the background region, which may be represented by Z_{t-1, fg}.

Based on this, Z_{t-1, fg} is used as the input latent variables for the next denoise processing (i.e., the latent variables corresponding to the foreground region), and the above fusion process and denoise processing are performed again until the latent variables corresponding to the foreground region is finally obtained, which is represented by Z_{1, fg}.

Afterwards, the fusion module is used to fuse the denoised latent variable Z_{1, fg}, corresponding to the foreground region with the latent variable Z_{1, bg} corresponding to the background region according to the mask image. That is, the foreground region in Z_{1, fg} is retained and the background region in Z_{1, fg} is eliminated, and the background region in Z_{1, bg} is retained and the foreground region in Z_{1, bg} is eliminated, so that the foreground region containing the image content modified to “a stone” and the original background region may be obtained to obtain the latent variables corresponding to the target image. Finally, the latent variables corresponding to the target image are denoised again based on text information such as “a stone” through the denoising module, that is, Z₀. After decoding processing by the decoding module, a more accurate target image is obtained, which contains the foreground region where the stone is located and the background region where the orange cat is located.

In some embodiments, as shown in FIG. 8, the corresponding image processing may be implemented respectively by the input module, the denoising module and the fusion module in the image processing system. After the initial image shown in FIG. 2 is obtained by using the input module, the initial image is firstly encoded by using the encoding module to obtain the latent variables corresponding to the initial image, and then the first noise data noise(t+1) is added to the latent variables corresponding to the initial image to obtain the latent variables corresponding to the initial image, i.e., Zₜ₊₁. Based on this, the following processing (i.e., the processing of the stage 1) is performed multiple times by the denoising module and the fusion module.

First, the denoising module is used to denoise the latent variables corresponding to the initial image based on the text information “a stone” to obtain the denoised latent variables corresponding to the foreground region of the initial image, which is represented by Z_{t, fg}.

Afterward, using a fusion module such as CFM and the mask image to process Z_{t, fg} to obtain the denoised latent variables corresponding to the foreground region. It should be noted that the hidden variables corresponding to the foreground region here refer to the hidden variables obtained after the hidden variables corresponding to the background region in the denoised initial image are processed to be null through the mask image.

Based on this, the denoised hidden variables corresponding to the foreground region output by the fusion module are used as the hidden variable Zₜ₊₁ corresponding to the initial image to re-execute the above process until the number of executions reaches the corresponding number.

After that, the denoised latent variables corresponding to the foreground region, which is finally output by the fusion module, is taken as Zₜ, and the following processing (i.e., the processing of stage 2) is performed t times through the denoising module and the fusion module.

First, the latent variables corresponding to the foreground region are fused with the latent variables corresponding to the initial image by using the mask image through the fusion module to obtain the latent variables corresponding to the intermediate image. The latent variables corresponding to the intermediate image include the latent variables corresponding to the foreground region participating in the fusion and the latent variables corresponding to the background region in the initial image, that is, the new Zₜ. It should be noted that the latent variables corresponding to the initial image here are added with the second noise data. The latent variables corresponding to the initial image used each time may be represented by Z_{t, bg}, Z_{t-1, bg}, . . . , Z_{2,bg}. Since each time the second noise data (such as noise(t) to noise(2)) added to the latent variables corresponding to the initial image is different, Z_{t, bg}, Z_{t-1, bg,} . . . , Z_{2,bg} are all different.

Then, the denoising module is used to denoise the latent variables corresponding to the foreground region in the intermediate image based on the text information. In this process, since the latent variables corresponding to the background region in the initial image are fused into the intermediate image, the latent variables corresponding to the foreground region in the intermediate image obtained by the denoise processing are obtained by modifying the image based on the text information in combination with the background region, which may be represented by Z_{t-1, fg}.

Based on this, Z_{t-1, fg} (i.e., the latent variables corresponding to the foreground region) is used as the input latent variables for the next denoise processing, and the above fusion process and denoise processing are performed again until the latent variables corresponding to the foreground region is finally obtained, which is represented by Z_{1, fg}.

Afterwards, the fusion module is used to fuse the denoised latent variables Z_{1, fg} corresponding to the foreground region with the latent variables Z_{1, bg} corresponding to the background region according to the mask image. That is, the foreground region in Z_{1, fg} is retained and the background region in Z_{1, fg} is eliminated, and the background region in Z_{1, bg} is retained and the foreground region in Z_{1, bg} is eliminated, so that the foreground region containing the image content modified to “a stone” and the original background region may be acquired to obtain the latent variables corresponding to the target image. Finally, the latent variables corresponding to the target image are denoised again based on text information such as “a stone” through the denoising module, that is, Z₀. After decoding processing by the decoding module, a more accurate target image is obtained, which contains the foreground region where the stone is located and the background region where the orange cat is located.

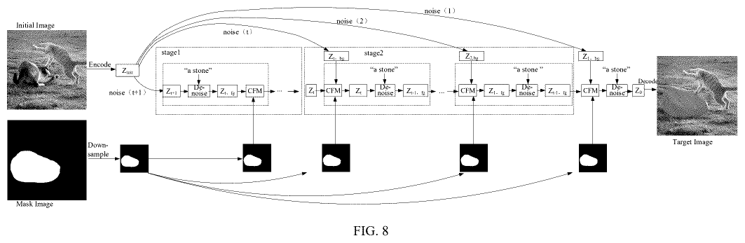

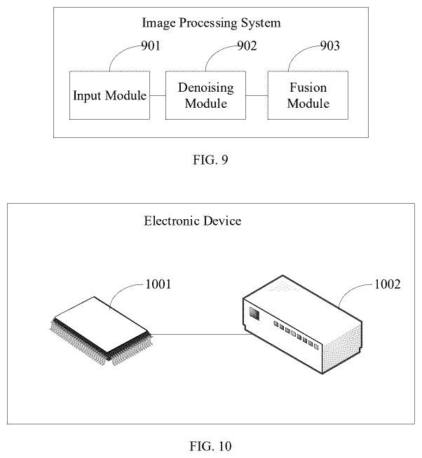

FIG. 9 is a schematic structural diagram of an image processing system, according to Embodiment 2 of the disclosure. The system may be run in an electronic device, and the system may include the following modules.

An input module 901, configured to obtain an initial image.

A denoising module 902, configured to perform denoise processing on latent variables corresponding to the initial image based on text information and a mask image to obtain latent variables corresponding to the first region in the initial image.

The text information is used to indicate modification of the image content of the first region, and the mask image corresponds to the first region.

A fusion module 903, configured to fuse the latent variables corresponding to the first region and latent variables corresponding to a second region using the mask image to obtain a target image, where the target image includes the first region in the initial image whose image content is modified and the second region in the initial image.

The second region is the remaining region in the initial image except the first region.

In addition, the image processing system may also include functional modules such as an encoding module and a decoding module. The encoding module is configured to encode the initial image to obtain latent variables corresponding to the initial image. The decoding module is configured to decode the obtained latent variables by fusing the latent variables corresponding to the first region and the latent variables corresponding to the second region to obtain the target image.

It can be seen that in an image processing system provided in Embodiment 2 of the disclosure, a mask image may be used to modify the image content of the first region in the initial image based on text information, and the image content of the first region may be modified and then fused with the remaining region. In this way, when performing image processing, the first region may be adjusted without causing major changes to the remaining region, thereby achieving regional adjustment of the image.

In some embodiments, there may be multiple denoising modules 902, and each denoising module 902 has an execution sequence, so that the denoise processing for the latent variables corresponding to the initial image is performed multiple times, and the latent variables output by a previous denoising module serve as the latent variables input into a next denoising module.

The denoising module 902 is further configured to add first noise data to the latent variables corresponding to the initial image before the first denoising module performs denoise processing on the latent variables corresponding to the initial image.

FIG. 10 is a schematic structural diagram of an electronic device, according to Embodiment 3 of the disclosure. The electronic device may include the following components.

A memory 1001, configured to store computer programs and data generated by the execution of the computer programs.

A processor 1002, configured to execute the computer programs to achieve: obtaining an initial image; based on text information and a mask image, denoising latent variables corresponding to the initial image to obtain latent variables corresponding to a first region in the initial image; where the text information is used to indicate modification of image content of the first region, and the mask image corresponds to the first region; using the mask image to fuse the latent variables corresponding to the first region and latent variables corresponding to a second region to obtain a target image, the target image including the first region in the initial image whose image content is modified and the second region in the initial image, where the second region is the remaining region in the initial image except the first region.

It can be seen that in an electronic device provided in Embodiment 3 of the disclosure, a mask image may be used to modify the image content of the first region in the initial image based on text information, and the image content of the first region may be modified and then fused with the remaining region. In this way, when performing image processing, the first region may be adjusted without causing major changes to the remaining region, thereby achieving regional adjustment of the image.

Taking a text-to-image diffusion model configured in the image processing system as an example, the technical solutions of the disclosure are described below.

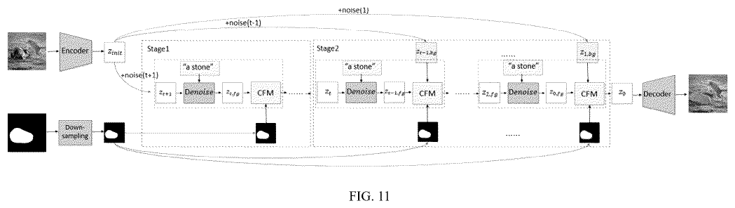

The text-to-image diffusion model runs a text-guided denoising diffusion model in a latent space learned by the variational autoencoder VAE=(Encoder, Decoder). As shown in FIG. 11, the specific process is as follows:

(1) Encode an image into latent variables Zᵢₙᵢₜ in advance through an encoder, and respectively add different degrees of noise to the initialized latent variables, to obtain the background latent variables {Z_{t, bg}, Z_{t-1, bg,} . . . , Z_{1, bg}} corresponding to each denoising operation.

(2) The mask image is downsampled in advance, to make the size consistent with the latent variables, and a mask corresponding to each denoising operation is then obtained by performing different degrees of smoothing operations on the initialized mask.

(3) In each denoising operation, the latent variable Zₜ₊₁ is first denoised using the text information such as “a stone” to obtain the foreground latent variable Z_{t, fg}. Then, the foreground latent variable Z_{t, fg}, the background latent variable Z_{t, bg}, the corresponding mask and the required parameters are input into the CFM module.

(4) The CFM module fuses different latent variables to obtain new latent variables. Considering the different focuses of the early and latent models in the denoising process, the CFM module processes the input variables differently.

First, in the early stage of denoising, that is, in the denoise processing of stage 1, CFM will just mask the foreground latent variables, so that the model may pay more attention to the content generation of the region within the mask under the guidance of the text.

Then, in the later stage of denoising, that is, in the denoise processing of stage 2, CFM will smooth the mask and then combine the foreground and background latent variables to make the foreground and background fuse more naturally.

(5) After completing all latent space denoising operations, the latent variables are decoded by the decoder to obtain a regionally edited image.

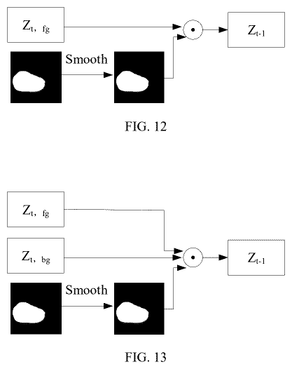

It should be noted that the fusion achieved by CFM in stage 1 is shown in FIG. 12. The CFM module uses mask to fuse Z_{t, fg} to obtain Zₜ₋₁. The fusion achieved by CFM in stage 2 is shown in FIG. 13. The CFM module uses mask to fuse Z_{t, fg} and Z_{t, bg} to obtain Zₜ₋₁.

For example, as shown in FIG. 11, in the first 20 denoising processes, namely the stage 1, in each denoise processing in the stage 1, the foreground latent variables are first denoised, and then the CFM fusion mask and the foreground latent variables are used, that is, the background latent variables are eliminated to extract new foreground latent variables, and then the new foreground latent variables are used as the input for the next denoising process, and so on, to complete 20 denoising processes. Afterwards, the foreground latent variables obtained from the first 20 denoising processes are used as input, and the next 30 denoising processes, namely the stage 2, are performed. In each denoise processing in the stage 2, the foreground latent variables are first denoised, and then the CFM fusion mask, foreground latent variables and background latent variables (the latent variables after Zᵢₙᵢₜ is denoised) are used. The obtained latent variables are then used as new foreground latent variables as input for the next denoising process, and so on. After 30 denoising processes, the full-image latent variables containing both foreground latent variables and background latent variables are obtained. At this moment, if the background latent variables used in the final fusion are added with noise data and the noise amplitude is zero, then the full-image latent variables are decoded, and the target image may be obtained after decoding, thereby achieving regional adjustment of the image without affecting the image content in the background region.

It should be noted that if the background latent variables used in the final fusion are added with noise data and the noise amplitude is not zero, at this moment, the full-image latent variables may be denoised based on the text information first, and after decoding, the target image may be obtained, thereby achieving regional adjustment of the image without affecting the image content of the background region.

In this specification, embodiments are described in a progressive manner, and each embodiment focuses on the differences from other embodiments. The same or similar parts between the embodiments may be referred to each other. For the described device embodiments, since they correspond to the method embodiments, the description is relatively simple, and the relevant parts may be referred to the method embodiments.

A person skilled in the art may further appreciate that the units and algorithm steps of each embodiment described in conjunction with the embodiments disclosed herein may be implemented in electronic hardware, computer software, or a combination thereof. In order to clearly illustrate the interchangeability of hardware and software, the composition and steps of each embodiment have been generally described in the above description according to function. Whether these functions are performed in hardware or software depends on the specific application and design constraints of the technical solutions. A person skilled in the art may use different methods to implement the described functions for each specific application, but such implementation should not be considered to be beyond the scope of the present disclosure.

The steps of the methods or algorithms described in conjunction with the embodiments disclosed herein may be implemented directly using hardware, a software module executed by a processor, or a combination thereof. The software module may be placed in a random access memory (RAM), a cache memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the disclosure. Various modifications to these embodiments will be apparent to those skilled in the art, and the general principles defined herein may be implemented in other embodiments without departing from the spirit or scope of the disclosure. Therefore, the disclosure will not be limited to the embodiments shown herein, but will conform to the widest scope consistent with the principles and novel features disclosed herein.

What is claimed is:

1. An image processing method, comprising:
obtaining an initial image;
based on text information and a mask image, performing denoise processing on latent variables corresponding to the initial image to obtain latent variables corresponding to a first region in the initial image, wherein the text information is used to indicate modification of image content of the first region, and the mask image corresponds to the first region; and
using the mask image to fuse the latent variables corresponding to the first region and latent variables corresponding to a second region to obtain a target image, the target image including the first region in the initial image whose image content is modified and the second region in the initial image, wherein the second region refers to a remaining region in the initial image except the first region.

2. The method according to claim 1, wherein:
the denoise processing on the latent variables corresponding to the initial image is performed multiple times, and latent variables obtained by a previous denoise processing are used as latent variables when the denoise processing is performed next time; and
before performing denoise processing on the latent variables corresponding to the initial image for a first time, the method further includes:
adding first noise data to the latent variables corresponding to the initial image.

3. The method according to claim 2, wherein performing denoise processing on the latent variables corresponding to the initial image in first N times comprises:
using the mask image to process the latent variables corresponding to the initial image to obtain the latent variables corresponding to the first region in the initial image; and
based on the text information, denoising the latent variables corresponding to the first region in the initial image to obtain denoised latent variables corresponding to the first region,
wherein N is a positive integer greater than or equal to 1.

4. The method according to claim 2, wherein performing denoise processing on the latent variables corresponding to the initial image in last M times comprises:
based on the text information, performing denoise processing on the latent variables corresponding to the initial image to obtain denoised latent variables corresponding to the initial image; and
using the mask image to process a denoised initial image to obtain latent variables corresponding to a denoised first region,
wherein M is a positive integer greater than or equal to 1.

5. The method according to claim 1, wherein, after obtaining the latent variables corresponding to the first region in the initial image and before fusing the latent variables corresponding to the first region with the latent variables corresponding to the second region, the method further includes implementing the following at least once:
using the mask image to fuse the latent variables corresponding to the first region with the latent variables corresponding to the initial image to obtain latent variables corresponding to an intermediate image; and
based on the text information, performing denoise processing on latent variables corresponding to the first region in the intermediate image to obtain denoised latent variables corresponding to the first region in the intermediate image.

6. The method according to claim 5, wherein, before fusing the latent variables corresponding to the first region with the latent variables corresponding to the initial image, the method further includes:
adding second noise data to the latent variables corresponding to the initial image,
wherein each time the fusing of the latent variables corresponding to the first region with the latent variables corresponding to the initial image is performed, the second noise data added to the latent variables corresponding to the initial image is different.

7. The method according to claim 2, wherein, before performing denoise processing on the latent variables corresponding to the initial image for the first time, the method further includes:
according to the latent variables corresponding to the initial image, downsampling the mask image so that the mask image and the latent variables corresponding to the initial image have a consistent image size; and
smoothing the mask image used in each execution of the denoise processing according to different processing parameters.

8. The method according to claim 1, wherein the latent variables corresponding to the second region is obtained by:
using a reverse mask image corresponding to the mask image to intercept the remaining region except the first region in the latent variables corresponding to the initial image to obtain the latent variables corresponding to the second region.

9. An image processing system, including a memory and one or more processors, wherein the memory stores a computer program executable by the one or more processors, and when executing the computer program, the one or more processor are configured to perform:
obtaining an initial image;
based on text information and a mask image, performing denoise processing on latent variables corresponding to the initial image to obtain latent variables corresponding to a first region in the initial image, wherein the text information is used to indicate modification of image content of the first region, and the mask image corresponds to the first region; and
using the mask image to fuse the latent variables corresponding to the first region and latent variables corresponding to a second region to obtain a target image, the target image including the first region in the initial image whose image content is modified and the second region in the initial image, wherein the second region refers to a remaining region in the initial image except the first region.

10. The image processing system according to claim 9, wherein:
the denoise processing on the latent variables corresponding to the initial image is performed multiple times, and latent variables obtained by a previous denoise processing are used as latent variables when the denoise processing is performed next time; and
before performing denoise processing on the latent variables corresponding to the initial image for a first time, the one or more processors are further configured to perform:
adding first noise data to the latent variables corresponding to the initial image.

11. The image processing system according to claim 10, wherein the one or more processors are further configured to perform:
using the mask image to process the latent variables corresponding to the initial image to obtain the latent variables corresponding to the first region in the initial image; and
based on the text information, denoising the latent variables corresponding to the first region in the initial image to obtain denoised latent variables corresponding to the first region,
wherein N is a positive integer greater than or equal to 1.

12. The image processing system according to claim 10, wherein the one or more processors are further configured to perform:
based on the text information, performing denoise processing on the latent variables corresponding to the initial image to obtain denoised latent variables corresponding to the initial image; and
using the mask image to process a denoised initial image to obtain latent variables corresponding to a denoised first region,
wherein M is a positive integer greater than or equal to 1.

13. The image processing system according to claim 9, wherein, after obtaining the latent variables corresponding to the first region in the initial image and before fusing the latent variables corresponding to the first region with the latent variables corresponding to the second region, the one or more processors are further configured to perform the following at least once:
using the mask image to fuse the latent variables corresponding to the first region with the latent variables corresponding to the initial image to obtain latent variables corresponding to an intermediate image; and
based on the text information, performing denoise processing on latent variables corresponding to the first region in the intermediate image to obtain denoised latent variables corresponding to the first region in the intermediate image.

14. The image processing system according to claim 13, wherein, before fusing the latent variables corresponding to the first region with the latent variables corresponding to the initial image, the one or more processors are further configured to perform:
adding second noise data to the latent variables corresponding to the initial image,
wherein each time the fusing of the latent variables corresponding to the first region with the latent variables corresponding to the initial image is performed, the second noise data added to the latent variables corresponding to the initial image is different.

15. The image processing system according to claim 10, wherein, before performing denoise processing on the latent variables corresponding to the initial image for the first time, the one or more processors are further configured to perform:
according to the latent variables corresponding to the initial image, downsampling the mask image so that the mask image and the latent variables corresponding to the initial image have a consistent image size; and
smoothing the mask image used in each execution of the denoise processing according to different processing parameters.

16. The image processing system according to claim 9, wherein the latent variables corresponding to the second region is obtained by:
using a reverse mask image corresponding to the mask image to intercept the remaining region except the first region in the latent variables corresponding to the initial image to obtain the latent variables corresponding to the second region.

17. A non-transitory computer-readable storage medium, storing a computer program that, when being executed, causes at least one processor to implement an image processing method comprising:
obtaining an initial image;
based on text information and a mask image, performing denoise processing on latent variables corresponding to the initial image to obtain latent variables corresponding to a first region in the initial image, wherein the text information is used to indicate modification of image content of the first region, and the mask image corresponds to the first region; and
using the mask image to fuse the latent variables corresponding to the first region and latent variables corresponding to a second region to obtain a target image, the target image including the first region in the initial image whose image content is modified and the second region in the initial image, wherein the second region refers to a remaining region in the initial image except the first region.

18. The non-transitory computer-readable storage medium according to claim 17, wherein:
the denoise processing on the latent variables corresponding to the initial image is performed multiple times, and latent variables obtained by a previous denoise processing are used as latent variables when the denoise processing is performed next time; and
before performing denoise processing on the latent variables corresponding to the initial image for a first time, the at least one processor is further caused to implement:
adding first noise data to the latent variables corresponding to the initial image.

19. The non-transitory computer-readable storage medium according to claim 18, wherein the at least one processor is further caused to implement:
using the mask image to process the latent variables corresponding to the initial image to obtain the latent variables corresponding to the first region in the initial image; and
based on the text information, denoising the latent variables corresponding to the first region in the initial image to obtain denoised latent variables corresponding to the first region,
wherein N is a positive integer greater than or equal to 1.

20. The non-transitory computer-readable storage medium according to claim 18, wherein the at least one processor is further caused to implement:
based on the text information, performing denoise processing on the latent variables corresponding to the initial image to obtain denoised latent variables corresponding to the initial image; and
using the mask image to process a denoised initial image to obtain latent variables corresponding to a denoised first region,
wherein M is a positive integer greater than or equal to 1.
